(19) United States
(12) Patent Application Publication
(10) Pub. No.: US 2016/0215796 A1
(43) Pub. Date: Jul. 28, 2016

(54) SYSTEM AND EQUIPMENT FOR SUPPLYING HIGH PRESSURE GAS USING SPECIAL HYDRAULIC OIL, IN A TRUCK TRACTOR USING VERTICAL OR HORIZONTAL CYLINDERS

(71) Applicant: NEOGÁS DO BRASIL GÁS NATURAL COMPRIMIDO S.A., Sao Leopoldo (BR)

(72) Inventor: Carlos Pereira GOUVÊA, Sao Pelegrino (BR)

(21) Appl. No.: 14/674,611

(22) Filed: Mar. 31, 2015

(30) Foreign Application Priority Data
Jan. 23, 2015 (BR) BR1020150016239

(51) Int. Cl. F15B 11/072; F15B 11/068; F15B 13/042; F15B 1/26

(52) U.S. Cl. CPC F15B 11/072; F15B 1/26; F15B 11/068; F15B 13/0424

(57) ABSTRACT

This invention concerns a system and equipment for supplying high pressure gas using special hydraulic oil which comprises a mobile hydraulic pressurization unit also known as an “HPU”, mounted on a truck which is connected to a semi-trailer comprising pressurized gas cylinders, where a pump, which activates a mobile hydraulic pressurization unit is coupled by a coupling device to the engine of the truck itself, and with pressurized gas cylinders with open upper and lower ends, comprising a single valve positioned at the upper end of the cylinders, which send the pressurized gas to a client, a single valve positioned at the lower end of the cylinders which both send hydraulic oil to the cylinders from an oil reservoir, and return the hydraulic oil to a hydraulic oil reservoir from the cylinders.

### BACKGROUND

1. Field

The invention concerns a system and equipment which allows the transportation and delivery of natural gas to a station or other place which does not have access to natural gas via pipelines, using a truck tractor. This is made possible through the combination of systems of storage and pressurization of special hydraulic oil which allows for the transference of up to 95% of the gas stored in cylinders to the client, maintaining, until the end of the supply process, constant filling pressure.

2. Description of the Related Art

The transportation of natural gas is made possible by various techniques and is done in various forms. Natural gas has the characteristic that even at high pressures the gas does not liquefy. Thus, if only compression is used, its transportation is carried out during the gaseous phase. As a result, the pressure parameters and their relationship to the quantity transported are a fundamental issue when it comes to ensuring that transportation and supply are economically viable. All the material is intended to be stored at high pressure and in an electrically classified area.

Another technique is cryogenic transportation. The natural gas is cooled to a much lower temperature, around −161° C. and at low pressure of less than 10 bar, resulting in gas in a liquid state. This enormously facilitates the transportation of the gas, bearing in mind that the cryogenic tank accommodates a much higher volume than the same volume of high pressure cylinders. The problem with this technique is not in the transportation or the re-vaporization and compression at the client's premises, but in the production of LNG (liquefied natural gas). The process of liquefaction is highly critical. Despite the fact that the design and construction techniques are fully understood, the process requires the use of specific, highly expensive materials, due to the extreme conditions of the temperature of the process. This greatly increases the cost of the process. Another important point is the factor of scale. LNG production plants are very expensive proportionate to the quantity of LNG produced. As such, the lower the production of an LNG plant, the greater will be its investment in US$/m³ produced. This greatly affects the applicability of this technique to smaller quantities. In this regard, our patent has a great advantage due to its economic viability in smaller quantities. This significantly broadens its scope for application.

Another technique is to use absorbent material combined with pressure. This comprises the use of a pressure cylinder or vessel filled with absorbent material. According to the authors Sidney Oliveira de Souza, Engenheiro Quimico, M. Sc., UFPE, Nelson Medeiros de Lima Filho Engenheiro Quimico, D. Sc., Docente, UFPE and Cesar Augusto Moraes de Abreu Engenheiro Quimico, D. Sc., Teacher, UFPE in the study Experimental Evaluation of the Loading Process for the Storage of Natural Gas by Absorption (Avaliaçao Experimental do Processo de Carga para o Armazenamento de Gás Natural por Adsorçao), in the last decade Absorbed Natural Gas (ANG) technology has emerged as a promising alternative for the storage of natural gas, offering various benefits in relation to the Compressed Natural Gas (CNG) process. The absorption of natural gas in porous materials at relatively moderate pressures (60 to 80 bar) brings various advantages, such as greater flexibility, to the design, configuration and arrangement of the storage tank, an increase in safety and a reduction of costs in comparison to the CNG process. Despite its promise the technique is not proven on a commercial scale but is the focus of continuing research.

Finally, the most common technique is the compression of natural gas, its transportation in a gaseous state compressed at high pressure, and its delivery to the premises of the client. There is a great number of ways to provide this service. I list various ways below by which it may be done.

One way of transporting compressed gas is transporting it in cylinder pallets which are transferred pallet by pallet. They are individually filled in compressed form and exchanged at the premises of the client as each pallet is consumed. The Galileu patents, numbers PI 0201043 and PI 0601501 use this process. The idea is interesting but transferring the pallets is very risky primarily due to their weight.

The patent of Gastron Comprimido S.A. number PI 0604520 for a rigid structure for the transportation of cylinders of fluids on the flat beds of trucks which can be coupled to a winching system also describes the use of a pallet.

Separated supply by pallets also causes operational difficulties at the level of compression. The use of this system also reduces the number of cylinders transported, reducing the volume and increasing the cost per m³ transported.

Neogas Inc has developed new technologies regarding the compression, transportation and transference of gas, such that the cylinders used have a mobile internal part which prevents the specially composed hydraulic oil from getting mixed with the gas.

Patent application PI 0208143-1 (WO 02075204; priority 16 Mar. 2001) of Igor Krasnov, refers to a compressed natural gas system, which is composed of a control section, a transference section, and a refueling section. The control section possesses a control panel and a hydraulic fluid reservoir, which contains hydraulic fluid (synthetic hydrocarbon hydraulic oil). The transference section is composed of banks of high pressure storage cylinders, with each bank containing an equal number of cylinders, which are identical in size. The hydraulic fluid ports of each cylinder in the bank of cylinders are coupled parallel to a fluid manifold, with each fluid manifold possessing a manual closing valve. The cylinders are composed of a first end and a second end, with the second end being closed. The first end possesses an opening into which an adaptation passes, which contains a hydraulic fluid port and a gas port. A tracking element is positioned in the interior of the cylinder chamber between the CNG and the hydraulic fluid. This tracking disc would require extremely high investment, in addition to the “almost impossible” maintenance of the disc in the interior of the cylinder, thus rendering it unviable.

This arrangement also possesses other disadvantages, which will be described below. The cylinders used, in addition to being difficult to maintain, in using the adaption produce an increase in the formation of emulsion, which is to say, friction between the oil and gas, and the flow resulting from this adaptation is reduced, producing a need for greater refueling time. The pressurizing system, in using a relief valve to maintain a pressure of 24.8 MPa, prevents the use of any type of cylinder and at any station, thus limiting its pressure, which today would limit the use of the system.

Another previous technique is described by document PI0006389-4 (Nov. 28, 2000) filed by Joseph Perry Conrad, which describes a cascade system for fueling natural gas. The system claimed is composed of a control section, a transference section and a refueling section. The control section is composed of a computerized control panel and a hydraulic fluid reservoir. The transference section is composed of two banks of high pressure storage cylinders, with each bank containing an equal number of cylinders, which are identical in size. Each cylinder contains an axial motion piston, two inlets at one of the ends and an outlet at the other end. The pistons separate the compressed natural gas from the hydraulic fluid. The inlets of the cylinders in each of the banks are positioned in parallel by inlet tubes.

In the compression technique, one of the forms is the use of a booster system to facilitate the removal of the gas from the containers, reducing logistical costs. An important aspect of this application is the consumption of the energy necessary for the work. The boosters operates at lower pressures and compresses the pressures to around 220 bar. The system developed by Neogas maintains the pressure which comes from the container, making it unnecessary to increase the pressure, and also improves the fueling times of clients. A very important point for the client is the fueling temperature of the gas, which in our system is lower than in the booster, because in our case it is not necessary to compress but to simply keep the gas compressed, with the gas remaining at the same temperature, unlike the situation with the booster which increases the pressure and, as a result, increases the temperatures. So more gas can be supplied with our system than with the booster.

The natural gas fueling systems known to the state of the art consist of equipping the fueling stations with hydraulic pressurization units (HPUs). This requires at least one hydraulic pressurization unit (HPU) to be installed in each fueling station. As such, the transportation e fueling of gas is limited to the stations which possess at least one hydraulic power unit.

One solution to the aforementioned problem of transportation and supply is provided by Neogas do Brasil, in the document for patent PI0603748-8, which describes a tractor equipped with hydraulic pressurization equipment (HPU) which can be incorporated into a semi-trailer vehicle composed of a series of vertical cylinders and/or a semi-trailer vehicle composed of a horizontal cylinder cart (caisson). The system described in this patent overcomes the deficiencies found in the state of the art, presenting hydraulic pressurization equipment which is capable of efficiently supplying motorized vehicles and of always keeping the same level of pressure. However, the system presents the inconvenience of comprising a complex and expensive execution valve activation system.

Thus, there is a need, in the state of the art, to find simpler, and consequently, lower cost gas supply systems and equipment, which can be transported on a truck-tractor.

So, in order to overcome the aforementioned problem of the state of the art, we hereby propose an improvement to the control of the valve system through the modification of the valve and pipe system. The modification proposed improves the activation of the valves which are activated pneumatically through a faster and, more importantly, synchronized action, which can easily be transported on a truck-tractor. The system hereby revealed also advantageously avoids incorporating an engine into the mobile hydraulic pressurization equipment, as the engine of the truck itself is used to activate the pump of the hydraulic pressurization system. The option to use extra light type IV cylinders was included. The back block system was withdrawn.

Before entering into details about the invention, it is important to demonstrate the scope of the use of the system. Both natural gas and biogas and treated biomethane can be used in the system. For a better understanding, see the definition of both below.

Natural gas is a fossil fuel formed when layers of buried animals and vegetables are exposed to intense heat and pressure over thousands of years. The energy that the plants naturally absorb from the sunlight is stored in carbon form in natural gas. It is a mixture of light hydrocarbons found in the subsoil, in which methane accounts for more than 70% by volume. The composition of natural gas can vary greatly depending on factors related to the field where the gas is produced, the production process, conditioning, processing and transportation. Natural gas is a fossil fuel and a non-renewable source of energy.

Biogas is the common name given to any gas produced by the biological breakdown of organic matter in the absence of oxygen. Normally it consists of a mixture of gases composed mainly of methane (CH4) and carbon dioxide (CO2), with small quantities of hydrogen sulfide (H2S) and humidity. Biomethane is processed biogas with the removal of the elements which do not add value to its use as carbon dioxide (CO2), hydrogen sulfide (H2S) and humidity.

The production of biogas occurs naturally in any submerged place where atmospheric oxygen cannot penetrate, such as in swamps, at the bottom of bodies of water, animal intestines, or in man-made form such as landfill and biogas plants.

### SUMMARY

This invention concerns a complete transportation and compression system using an HPU (Hydraulic Pressurization Unit), which is mounted on top of a truck and duly connected to a gas container, semi-trailer vehicle (SRV) which may have vertical or horizontal cylinders adapted to use the technology employed to keep the pressure of the semi-trailer constant during its fueling operation. The invention comprises a simplification of the hydraulic pressurization systems and equipment. The change to the system for sending and returning the oil and the reduction in the pneumatically activated valves, makes the control system easier, quicker and, by synchronizing the action of the former, improves the performance of the system allowing for more precise responses. The reduction of the control systems also reduces maintenance problems.

In the gas pressurization system already known, the sending and return of the oil from the HPU to the SRV was performed through two lines, one for the sending and the other for the return of the oil, as explained in document I0603748-8A. Each pallet, which is a collection of cylinders interconnected by tubes, required a manual blocking valve and two valves activated by compressed air. The system, thus, comprises various valves and requires considerable space to accommodate all the valves, taking up space where cylinders could be mounted and, thus, reducing the capacity to transport gas.

The equipment which will be described here comprises an HPU mounted on a truck composed of a coupling system for connecting the truck engine and the hydraulic pump, hydraulic reservoir and special hydraulic oil, a sending block and system for returning the oil and cylinder pallets.

The container pallets are formed of a cylinder or collection of cylinders, with each cylinder possessing two necks for connection to the system. At the end of the outlet, there is a ball valve connected to the line of the natural gas outlet, and at the end of the inlet there is only a ball valve, where one of the ends of the valve is connected in parallel, and one of the other ends is connected to the sending line and the other to the return line. The specially composed hydraulic fluid is pumped through the sending line from the reservoir to the end of the inlet of the cylinders, to maintain a pressure of 220 to 250 Bar in the cylinders, while the CNG is being supplied to the consumer.

The supply process begins with the filling of the container of the pallets at a natural gas fueling station. The cylinders are filled at a filling pressure compatible with the design of the cylinders. The transportation is carried out by the semi-trailer vehicle, which has a mobile HPU installed in it, to the natural gas fueling station.

The motive element is the oil pump and the specially composed hydraulic oil which is what causes the energy of this pump to be transferred to the gas and provide a constant pressure or 200 to 250 bar. The oil enters the cylinders and keeps the pressure constant, compensating for the pressure which would fall with the withdrawal of the gas. When there is no longer sufficient gas to continue with the supply of this pallet, the oil is sent back to the oil reservoir. It is important to note that the same pipe which sends the oil is also the return pipe. This return of the oil is effected at the pressure of the gas itself which pushes the oil back, with only a residual pressure remaining.

Simultaneously, the PLC (programmable logic controller) of the Mobile HPU orders the sending of the hydraulic fluid to the second pallet of cylinders.

The end of each cycle occurs when the volume of gas sent reaches 95% of the total volume of the pallet. At this moment, the gas outlet valve is closed, the oil begins to return, forced by the pressure of the gas, and goes to the oil reservoir. The entire control of the volume of the oil sent and returned is carried out by a gauge installed in the oil tank. This information is processed in the PLC which monitors all the events which occur in the equipment, controlling the operations, making their operation automatic and keeping a manual option open.

### BRIEF DESCRIPTION OF THE DRAWINGS

FIG. 1—illustrates the schematic diagram of the Mobile HPU And SRV in accordance with the invention;

FIG. 2—illustrates the schematic diagram of the Mobile HPU;

FIG. 3—illustrates the schematic diagram of the SRV, which is coupled to the tractor-truck;

FIG. 4A—illustrates the internal detail of the gas inlet, located in the upper part of the vertical type cylinder;

FIG. 4B—illustrates the internal detail of the flow inlet/outlet, located in the lower part of the vertical type cylinder;

FIG. 4C—illustrates the mounted cylinder presenting the adaptations of FIGS. 4A and 4B;

FIG. 5A—illustrates the internal detail of the gas inlet, located in the upper part of the horizontal type cylinder (caisson);

FIG. 5B—illustrates the internal detail of the flow inlet/outlet, located in the lower part of the horizontal type cylinder (caisson);

### DETAILED DESCRIPTION

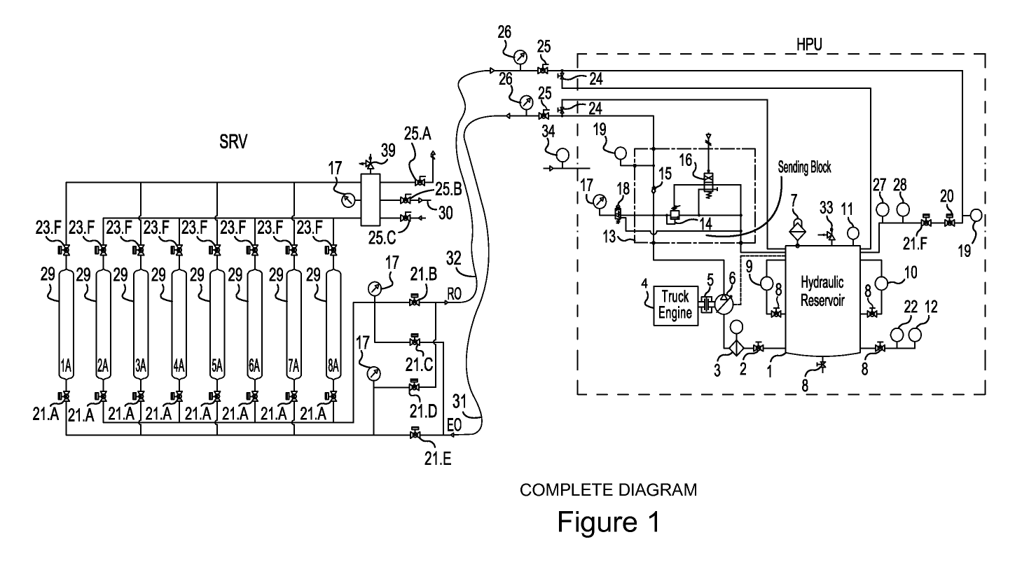

The invention will now be described with reference to FIGS. 1 to 5, as follows below.

The Mobile HPU is a high pressure generation module using specially composed hydraulic oil, which is connected to a container composed of vertical or horizontal cylinders, where the natural gas which will supply the client is contained.

The entire system has a series of safety devices which, in some cases, are redundant. All the cylinders have an excess pressure and temperature device. The high pressure oil line has a pressure relief valve.

The entire design has been made in accordance with rigorous safety criteria. The oil suction and discharge lines are designed for 350 bar, although they operate at a much lower pressure.

The technology allows the transference of up to 95% of the gas which is stored at a constant pressure of 200 to 250 bar.

FIG. 1 presents a Mobile HPU (hydraulic pressurization unit) connected to an SRV (semi-trailer vehicle), where, when the system is operating, the hydraulic oil from hydraulic reservoir 1 of the HPU is compressed and sent to cylinders 1A, 2A, 3A, 4A, 5A, 6A, 7A and 8A of the SRV through hydraulic fluid feed line 37.

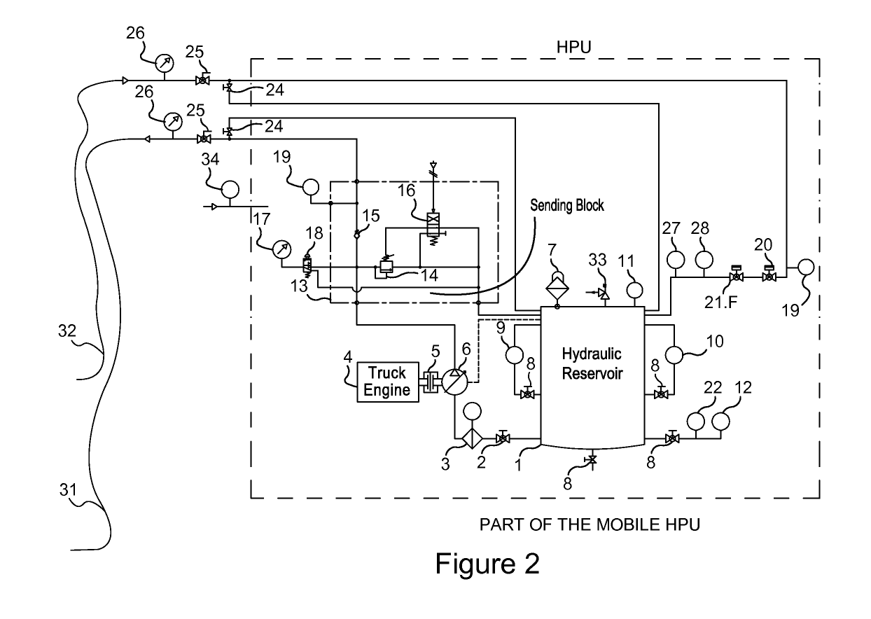

FIG. 2 shows the Mobile HPU which encompasses the entire hydraulic system, including oil reservoir 1, the engine of the truck 4 with the coupling 5 of the hydraulic pump 6, oil sending block 13, oil return system 20. The whole system is controlled by an electric panel commanded by a PLC (not shown).

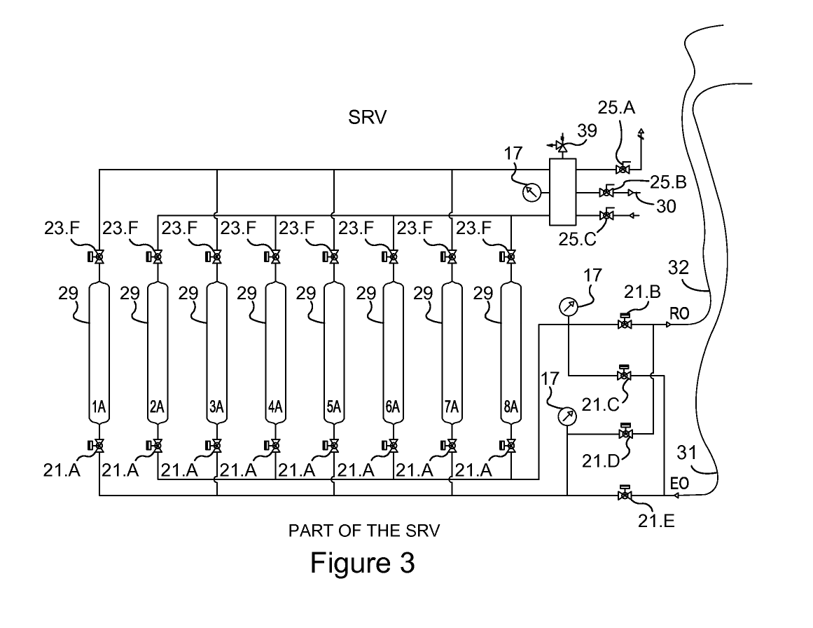

FIG. 3 shows the SRV, which encompasses the collection of pallets of cylinders, here represented by pallets 1A, 2A, 3A, 4A, 5A, 6A, 7A and 8A. However, it should be understood that each pallet may encompass a pipe or collection of cylinders. As shown in FIGS. 1 and 3, each gas cylinder encompasses a single valve 23A installed in one of the open ends of the cylinder which allows both the entry of hydraulic oil from the hydraulic oil reservoir 1 into the cylinders, and the return of this oil to the reservoir.

The operation of the equipment is based on the compression of the specially composed hydraulic oil. This oil is stored in the 3,000 liter oil reservoir. The oil passes through the blocking valve 2 and through the filter 3 until arriving at the pump apparatus 6 and the engine of the truck itself 4 activates the pump 6 of the Mobile HPU. These are connected by a coupling device 5 which allows the transmission of the rotation of the engine of the truck 4 to the oil pump 6. The oil, which is already compressed, goes to the sending block 13. The regulation of the pressure is performed at the relief valve 14. It is activated through the directional valve 16 which is activated by compressed air. When the directional valve 16 is without air, in the direct passage position, the relief valve 14 is not activated and causes the oil to re-circulate throughout the system without sufficient pressure to overcome the force of the spring of the retention valve 15. When the directional valve 16 is activated, it acts directly on the spring of the relief valve 14 commanding it and causing the oil to pass through the system at the pre-regulated pressure.

The oil continues and proceeds to the retention valve 15 and, after this, the pressure is Measured continuously through the pressure transmitter 19. The pressurized oil continues through the hydraulic fluid feed line 37, passing through the valve 29 and manometer 30, to the valve system with the pneumatic activator 23E and 23C. The valves 23E and 23C allow the control of the sending of the hydraulic oil to the gas cylinder pallets through the two oil inlet lines which are connected to the end of the inlet of the cylinders which encompasses only one valve 23A.

When 95% of the gas contained in the cylinders (1A, 2A, 3A, 4A, 5A, 6A, 7A and 8A) is transferred to the client, which is to say, when the volume of the hydraulic oil reaches 95% of the capacity of each pressurized gas cylinder, the valves 23B and 23D allow the return of the hydraulic oil to the oil reservoir 1. The hydraulic oil then returns from the cylinders to the reservoir 1 passing through the same valve 23A and oil conductor pipe until it reaches the valves 23B and 23D which allow the hydraulic oil to pass to the return line 38, as shown in FIGS. 1, 2 and 3.

In the previous pressurized gas supply systems, each pallet of cylinders comprises 02 valves connected to the end of the hydraulic oil inlet, with one valve being for the entry of the oil into the cylinder and the other for the return of this oil to the hydraulic fluid reservoir. Now, with this invention, both the entry of the oil into the cylinder 1A, 2A, 3A, 4A, 5A, 6A, 7A and 8A and its return to the hydraulic fluid reservoir 1 are carried out through a single valve 23A, which connects the end of the inlet of each cylinder (1A, 2A, 3A, 4A, 5A, 6A, 7A and 8A) to the oil conducting pipes.

The inclusion of the 4 valves 23 (B, C, D and E) in this pressurized gas supply system allows only one valve 23A to be installed at the end of the inlet of the cylinders. In addition to this, the arrangement of the valves 23 (B, C, D, E) together allows the system to be controlled in a quicker and more synchronized manner.

Thus, the invention comprises pipes and valves with a logic which reduces the number of valves, with a reduction in costs and space in the container which will allow for the inclusion of more cylinders, thus increasing the quantity of gas transported, bearing in mind that the system of two valves per pallet allows the number of valves to be such that a tunnel or pathway is kept reserved between the cylinders.

The principal advantage achieved with this system is the improved control of the HPU. The reduced number of valves and the arrangement of the 4 valves 23 (B, C, D and E) together as opposed to the 01 pair of valves in each pallet, will allow the system to be activated more quickly and to be opened and closed at the same time leading to improved synchronization of the system. The smaller number of valves will reduce maintenance events. The sending and return of the oil from the HPU to the SRV, which was previously done through two lines, one for the sending and the other for the return of the oil, is now carried out by a single valve 23A and oil conducting pipe. The previous pressurizing system works well, but each pallet needs a manual blocking valve and two valves activated by compressed air. This system, therefore, contains an excessive number of valves and requires considerable space to accommodate all the valves, taking up space where cylinders could be mounted. The proposed system uses two lines, with both working to send the hydraulic oil and return it to the hydraulic fluid reservoir, serving a different group of pallets. One line serves pallets 1A, 3A, 5A, 7A etc and the other line serves pallets 2A, 4A, 6A, 8A, etc.

Thus, the valves 23 (B, C, D and E) perform the control and sending to the pallets commanded by the PLC. The control of the valves is carried out electronically, as already shown in document PI0603748-8A and, for that reason, will not be discussed here in greater detail.

When the valves 23 B and E are open, the valves 23 C and 23 D are closed. Valve 23 E channels the oil from the hydraulic reservoir to the cylinders 1A, 3A, 5A and 7A, while 23 B channels the oil from the pallet to the hydraulic reservoir 1. They always work together. When the set of cylinders 1A, 3A, 5A, 7A is empty, valves 23 B and E close and valves 23 C and D open, with valve 23 C channeling the oil from the pallets to the hydraulic reservoir and valve 23 D channeling the oil from the hydraulic reservoir to the pallets, initiating the transference of the pressurized gas from the set of cylinders 2A, 4A, 6A and 8A to the client, followed by the return of the hydraulic oil to reservoir 1.

Each pallet which was sending or receiving oil has its respective valve 23A which is activated pneumatically and opened, while all the other valves 23A are closed. As soon as the pallets in use are changed, the respective valves 23A open when in use and close when not in operation.

The pallet which is returning the oil to the tank passes through the high pressure return line 38. The oil returns after 95% of the gas in the pallet is sent to the client. The pressurized oil sent to the pallet is able to pressurize the gas, keeping the pressure constant within the cylinder. The system changes pallet with the closing of the pneumatically activated valve 27F. The set of pneumatically activated valves 23 changes from open to closed. The valves 23B and 23E close and valves 23C and 23D open. The oil passes through the pipe 37 proceeding in the direction of the pallets of cylinders, while in the pipe 38 the oil continues in the direction of the oil tank.

The valves with a pneumatic activator 22 and 23F work in conjunction. Firstly, the oil passes through valve 22, which has a calibrated orifice in its pathway, and then through valve 23F. Valve 23F does not have this orifice. The PLC commands the operation. When the oil begins to return, the pneumatically activated valves 23 and 23F open. As soon as the outflow of oil begins to reduce, valve 22 with its calibrated orifice is opened (it is opened to allow full passage and not through the orifice).

Before entering the hydraulic reservoir, there are two optical sensors. The first photoelectric sensor 34 and the pen photoelectric sensor 33 verify the oil which is passing through. The sensors verify whether only oil is passing through or if any gas is already passing through. The return of the oil occurs in repeated cycles so that the maximum quantity of oil is taken from the pallets.

While the lower part of the pallets works with oil, the upper part works with gas. Each pallet has a pneumatically activated valve 23 for its opening or closing.

There are two possible types of cylinders: steel cylinders and type 4 cylinders.

Within the cylinders of the pallet, even with the gas outlet on top of the cylinder, the pressure remains constant due to the injection of oil which is carried out from below. The system works to keep this balance, which is to say, the hydraulic system sends oil with the due alignment of the activated valves 23 C and E and the gas is sent to supply the client, whether it be a vehicle, storage area of another container. The compressed gas passes through a block where there is a relief valve 39, a connection for filling the container 29A, an outlet for the client's filling line 29B and a vent valve 29C which allows the uncoupling of the hosepipe connection.

The high pressure gas line 36 takes the gas to the cylinder 31 which allows the gas to expand and be able to condense some liquid matter from the pallet there. The gas which leaves this cylinder passes through a filter 32 and then through a pneumatically activated valve 27 and finally through a manometer 30.

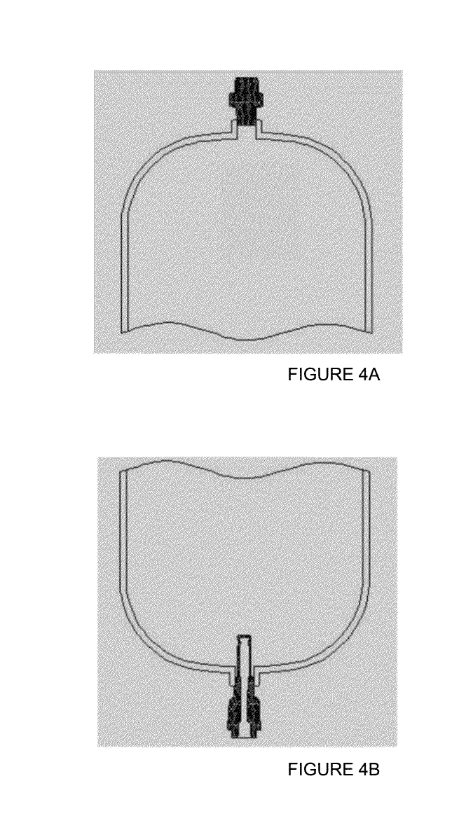

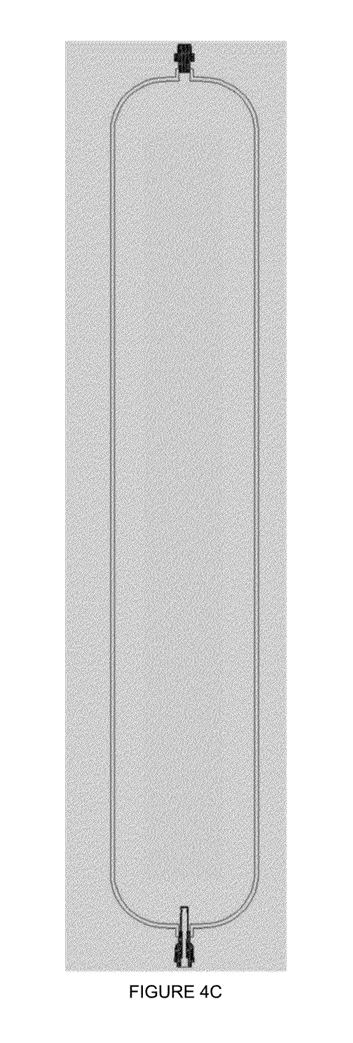

FIGS. 4A, 4B and 4C illustrate, respectively, the internal detail of the gas inlet and the internal detail of the hydraulic oil flow inlet/outlet located in the upper part of the vertical type cylinder, already known to the state of the art, and which may be used together with the gas supply system of this invention. FIG. 4C illustrates the mounted cylinder presenting the adaptations shown in FIGS. 4A and 4B.

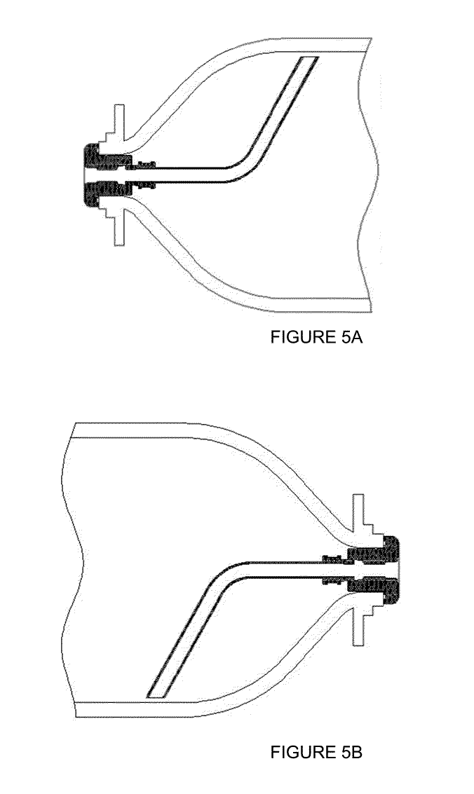

FIGS. 5A and 5B show, respectively, the internal detail of the gas inlet and the internal detail of the hydraulic oil flow inlet/outlet, located in the upper part of horizontal type cylinder (caisson), already known from the documents of patent PI0603748-8, which may be used with the gas supply system of this invention.

The adaptations of FIGS. 5A and 5B present a curved adaptation for use in a horizontal cylinder (known as a caisson). The adaptations of both the ends of the horizontal cylinder consist of a curved pipe, with their radius determined by the bend radius of the ends of the cylinder. The function of the adaptation illustrated in FIG. 5A is to increase the efficiency of the supply of compressed gas and prevent the gas entry line from receiving hydraulic fluid. The function of the adaptation illustrated in FIG. 5B is to ensure that the oil enters the cylinder in a homogeneous manner preventing the squirting of oil in the internal part of the cylinder.

It may be observed that this invention is not limited to what is described above, but may be modified according to the inventive concept and scope defined in the claims.

1. High pressure gas supply system with use of special hydraulic oil and a truck-tractor comprising a mobile hydraulic pressurization unit (HPU), with a vehicular container with pressurized gas cylinders (1A, 2A, 3A, 4A, 5A, 6A, 7A and 8A) where each cylinder comprises an open lower end to receive hydraulic fluid and an open upper end, for sending pressurized gas to a client, where the Mobile HPU comprises:
a hydraulic fluid reservoir (1) connected to a pump system (6), which sends hydraulic oil to the sending block (13);
a sending block (13) composed of a directional valve (16), a relief valve (14), a retaining valve (15) and a pressure transmitter (19), capable of sending hydraulic oil from the oil reservoir (1) to the gas cylinders through the oil conducting pipes (37), which then forces the pressurized gas out of the cylinders (1A, 2A, 3A, 4A, 5A, 6A, 7A and 8A);
photoelectric sensors (33, 34), valves with pneumatic activators 22 and 23F. Valve 22, which has in its passage area a calibrated orifice, and valve 23F which does not have this orifice, and is able to return the hydraulic oil to the oil reservoir (1), through the return pipe (38), after 95% of the volumetric capacity of each cylinder is removed from the cylinders (1A, 2A, 3A, 4A, 5A, 6A, 7A and 8A);
CHARACTERIZED by the fact that the pump (6) is coupled by a coupling device (5) to the engine (4) of the truck-tractor itself, which activates the pump (6) which moves the hydraulic oil, so that the pressurized gas cylinders (1A, 2A, 3A, 4A, 5A, 6A, 7A and 8A) of the vehicular container receive the special hydraulic oil from the oil reservoir (1) through the sending pipe (37) which is connected to the lower end of the cylinder pallets (1A, 2A, 3A, 4A, 5A, 6A, 7A and 8A) through a single control valve (23A) and which returns the hydraulic oil to the reservoir (1) through the same valve (23A) via the return pipe (38).

2. High pressure gas supply equipment to be used in a gas supply system as defined in claim 1, CHARACTERIZED by the fact that the pressurized gas cylinders (1A, 2A, 3A, 4A, 5A, 6A, 7A and 8A) of the semi-trailer vehicle, coupled to the truck-tractor comprise:
only one valve (23A) at the lower end of each pressurized gas cylinder (1A, 2A, 3A, 4A, 5A, 6A, 7A e 8A), where valve 23A controls both the sending of the special hydraulic oil from the oil reservoir (1) to the cylinders, through the sending pipe (37), and the return of the hydraulic oil from the cylinders (1A, 2A, 3A, 4A, 5A, 6A, 7A and 8A) to the oil reservoir (1), through the return pipe (38);
only one valve (27F) at the upper end of each pressurized gas cylinder (1A, 2A, 3A, 4A, 5A, 6A, 7A and 8A), where valve 27F controls the sending of pressurized gas to supply a client; and
a set of valves (23B, 23C, 23D, 23E), arranged separately from the pressurized gas cylinders (1A, 2A, 3A, 4A, 5A, 6A, 7A and 8A) of the semi-trailer, where the valves (23C and 23E) control the sending of the special hydraulic oil from the oil reservoir (1) to the cylinders (1A, 2A, 3A, 4A, 5A, 6A, 7A e 8A), up to valve 23A positioned at the lower end of each cylinder (1A, 2A, 3A, 4A, 5A, 6A, 7A and 8A);
and where the valves (23B and 23D) control the return of the special hydraulic oil through the return pipe (38), from the cylinders (1A, 2A, 3A, 4A, 5A, 6A, 7A and 8A), passing through the valve (23A) at the lower end of the cylinders (1A, 2A, 3A, 4A, 5A, 6A, 7A and 8A) to the hydraulic oil reservoir (1).

3. System in accordance with claim 1, CHARACTERIZED by the fact that the cylinders (1A, 2A, 3A, 4A, 5A, 6A, 7A and 8A) of the semi-trailer may be formed of sets of vertical cylinders grouped together or by a single horizontal cylinder (caisson).

4. System in accordance with claim 1, CHARACTERIZED by the fact that each module of cylinders must have the same volumetric capacity.

5. Truck-tractor for use with vertical or horizontal pressurized gas storage cylinders which comprises an engine (6) CHARACTERIZED by the fact that the engine (6) of the truck is coupled by a coupling device (5) to the pump (6) which moves the hydraulic fluid of the mobile pressurization equipment (HPU), as defined in claim 1.

6. High pressure gas supply system with use of special hydraulic oil and a truck-tractor comprising a mobile hydraulic pressurization unit (HPU), with a vehicular container with pressurized gas cylinders where each cylinder comprises an open lower end to receive hydraulic fluid and an open upper end, for sending pressurized gas to a client, where the Mobile HPU comprises:
a hydraulic fluid reservoir connected to a pump system, which sends hydraulic oil to a sending block;
the sending block, said sending block comprising a directional valve, a relief valve, a retaining valve and a pressure transmitter, configured to send hydraulic oil from the oil reservoir to the gas cylinders through oil conducting pipes, which then forces the pressurized gas out of the cylinders;
photoelectric sensors, first and second valves with pneumatic activators, wherein the first valve has in its passage area a calibrated orifice, and wherein the second valve does not have this orifice, and is configured to return the hydraulic oil to the oil reservoir, through a return pipe, after 95% of the volumetric capacity of each cylinder is removed from the cylinders;
wherein the pump system is coupled by a coupling device to an engine of the truck-tractor, which activates the pump system which moves the hydraulic oil, so that the pressurized gas cylinders of the vehicular container receive the special hydraulic oil from the oil reservoir through a sending pipe of the oil conducting pipeswhich is connected to the lower end of the cylinder pallets through a single control valve and which returns the hydraulic oil to the reservoir through the single control valve via the return pipe.

7. High pressure gas supply equipment to be used in a gas supply system as defined in claim 6, wherein the pressurized gas cylinders of the semi-trailer vehicle, coupled to the truck-tractor, comprise:
one a lower end valve at the lower end of each pressurized gas cylinder, where the lower end valve controls both the sending of the special hydraulic oil from the oil reservoir to the cylinders, through the sending pipe, and the return of the hydraulic oil from the cylinders to the oil reservoir, through the return pipe;
and upper end valve at the upper end of each pressurized gas cylinder, where the upper end valve controls sending of pressurized gas to supply a client; and
a set of valves comprising a first subset and a second subset, arranged separately from the pressurized gas cylinders of the semi-trailer, where the first subset of valve control the sending of the special hydraulic oil from the oil reservoir to the cylinders, up to the lower end valve positioned at the lower end of each cylinder;
and where the second subset of valves control the return of the special hydraulic oil through the return pipe, from the cylinders, passing through the lower end valve at the lower end of the cylinders to the hydraulic oil reservoir.

8. System in accordance with claim 6, wherein the cylinders of the semi-trailer may be formed of sets of vertical cylinders grouped together or by a single horizontal cylinder (caisson).

9. System in accordance with claim 6, wherein each module of cylinders has a same volumetric capacity.

10. Truck-tractor for use with vertical or horizontal pressurized gas storage cylinders, wherein the engine of the truck is coupled by a coupling device to the pump system which moves the hydraulic fluid of the mobile pressurization equipment (HPU), as defined in claim 6.
